(19) United States
(12) Patent Application Publication
(10) Pub. No.: US 2025/0081117 A1
(43) Pub. Date: Mar. 6, 2025

(54) TRANSMITTING ON NON-IMPAIRED PORTS FOR LAYER REDUCTION

(71) Applicant: QUALCOMM Incorporated, San Diego, CA (US)

(72) Inventor: Akash KUMAR, Hyderabad (IN)

(21) Appl. No.: 18/462,057

(22) Filed: Sep. 6, 2023

(51) Int. Cl. H04W 52/14; H04W 52/36; H04W 72/1268

(52) U.S. Cl. CPC H04W 52/146; H04W 52/367; H04W 72/1268

(57) ABSTRACT

Various aspects of the present disclosure generally relate to wireless communication. In some aspects, a user equipment (UE) may detect an impaired power limited port of the UE. The UE may refrain from transmitting an uplink signal on the impaired power limited port. The UE may transmit the uplink signal on remaining non-impaired ports based at least in part on an uplink transmit power splitting applied amongst the remaining non-impaired ports. Numerous other aspects are described.

### FIELD OF THE DISCLOSURE

Aspects of the present disclosure generally relate to wireless communication and to techniques and apparatuses for transmitting on non-impaired ports for layer reduction.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes one or more memories; and one or more processors coupled to the one or more memories, the one or more processors configured to: detect an impaired power limited port of the UE; refrain from transmitting an uplink signal on the impaired power limited port; and transmit the uplink signal on remaining non-impaired ports based at least in part on an uplink transmit power splitting applied amongst the remaining non-impaired ports.

In some implementations, an apparatus for wireless communication at a network node includes one or more memories; and one or more processors coupled to the one or more memories, the one or more processors configured to: receive, via a plurality of ports, an uplink signal; detect, for a port associated with the plurality of ports, an uplink transmit power associated with the port, wherein the port is an impaired power limited port or a non-impaired port depending on the uplink transmit power associated with the port; and perform an action based at least in part on the uplink transmit power associated with the port.

In some implementations, a method of wireless communication performed by a UE includes detecting an impaired power limited port of the UE; refraining from transmitting an uplink signal on the impaired power limited port; and transmitting the uplink signal on remaining non-impaired ports based at least in part on an uplink transmit power splitting applied amongst the remaining non-impaired ports.

In some implementations, a method of wireless communication performed by a network node includes receiving, via a plurality of ports, an uplink signal; detecting, for a port associated with the plurality of ports, an uplink transmit power associated with the port, wherein the port is an impaired power limited port or a non-impaired port depending on the uplink transmit power associated with the port; and performing an action based at least in part on the uplink transmit power associated with the port.

In some implementations, a non-transitory computer-readable medium storing a set of instructions for wireless communication includes one or more instructions that, when executed by one or more processors of a UE, cause the UE to: detect an impaired power limited port of the UE; refrain from transmitting an uplink signal on the impaired power limited port; and transmit the uplink signal on remaining non-impaired ports based at least in part on an uplink transmit power splitting applied amongst the remaining non-impaired ports.

In some implementations, a non-transitory computer-readable medium storing a set of instructions for wireless communication includes one or more instructions that, when executed by one or more processors of a network node, cause the network node to: receive, via a plurality of ports, an uplink signal; detect, for a port associated with the plurality of ports, an uplink transmit power associated with the port, wherein the port is an impaired power limited port or a non-impaired port depending on the uplink transmit power associated with the port; and perform an action based at least in part on the uplink transmit power associated with the port.

In some implementations, an apparatus for wireless communication includes means for detecting an impaired power limited port of the apparatus; means for refraining from transmitting an uplink signal on the impaired power limited port; and means for transmitting the uplink signal on remaining non-impaired ports based at least in part on an uplink transmit power splitting applied amongst the remaining non-impaired ports.

In some implementations, an apparatus for wireless communication includes means for receiving, via a plurality of ports, an uplink signal; means for detecting, for a port associated with the plurality of ports, an uplink transmit power associated with the port, wherein the port is an impaired power limited port or a non-impaired port depending on the uplink transmit power associated with the port; and means for performing an action based at least in part on the uplink transmit power associated with the port.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIGS. 4-5 are diagrams illustrating examples associated with transmitting on non-impaired ports and/or impaired power limited ports for layer reduction, in accordance with the present disclosure.

FIGS. 6-7 are diagrams illustrating example processes associated with transmitting on non-impaired ports and/or impaired power limited ports for layer reduction, in accordance with the present disclosure.

FIGS. 8-9 are diagrams of example apparatuses for wireless communication, in accordance with the present disclosure.

### DETAILED DESCRIPTION

An uplink multiple-input multiple-output (MIMO) configuration may be deployed in a New Radio (NR) system to improve and boost an uplink throughput. In an uplink MIMO mode, a user equipment (UE) may use an indicated precoding matrix to multiplex multiple streams of data over one radio configuration using multiple physical antennas and/or ports (e.g., antenna ports). An uplink power control may be on a per carrier basis. The UE may split a computed uplink transmit power equally amongst active uplink ports for a given uplink transmission, in order to achieve a required uplink transmit power. As per a precoding matrix (e.g., a precoding matrix for a two-layer transmission using two ports) used for any form of uplink MIMO (e.g., coherent, non-coherent, or partially coherent), the uplink transmit power should be the same on all ports.

In some scenarios, an uplink transmit power of a certain port of the UE may be limited in relation to uplink transmit powers of other ports. For example, the uplink transmit power of the port may be limited due to the port being within a vicinity to a camera, a microphone, or some other subsystem, but other ports may not be subjected to such uplink transmit power limits. The uplink transmit power of the port may be limited, in relation to the uplink transmit powers of other ports, based at least in part on a specific absorption rate (SAR) limit for different ports in different antenna groups. The uplink transmit power of the port may be limited due to a coexistence limit (e.g., different antenna isolation for a victim) or due to a thermal effect specific to a power amplifier. In such scenarios, not all ports may inherently be associated with the same uplink transmit power.

However, due to the requirement to transmit using the same uplink transmit power on all ports associated with uplink MIMO, the uplink transmit power for all ports may be limited to a minimum of a power permissible across all ports. In other words, when one port is limited to a low uplink transmit power, but other ports are able to support a high uplink transmit power, all ports must be constrained to the low uplink transmit power due to the requirement in uplink MIMO that all ports transmit using the same uplink transmit power. Under such scenarios, an uplink transmit power of an overall carrier may become significantly power limited.

A network node may be unable to detect this specific scenario (e.g., a specific port power reduction causing an overall carrier power limiting), so the network node may throttle (e.g., reduce) an uplink grant (e.g., throttle resource blocks and/or an MCS) in response to a relatively high block error rate (BLER) as part of an outer loop link adaptation. When one port is power constrained (even though other ports may not be power constrained), the reduction in uplink transmit power may reduce an overall performance of the UE and/or the network node. Further, when the network node throttles the uplink grant in response to the reduction in uplink transmit power, without an ability to detect that the reduction in uplink transmit power is due to the specific port power reduction, an overall performance of the UE and/or the network node may be degraded. The network node may throttle the uplink grant in response to the UE becoming power limited, which may lead to a significant uplink throughput degradation, especially when power on a specific transmit chain, port, and/or antenna is severely power limited.

Various aspects relate generally to transmitting on non-impaired ports and/or impaired power limited ports for layer reduction. Some aspects more specifically relate to transmitting uplink signals on non-impaired ports and/or impaired power limited ports, which may cause a network node to implement the layer reduction. In some examples, a UE may detect an impaired power limited port of the UE. The UE may detect that a certain port is the impaired power limited port based at least in part on an uplink transmit power associated with the port. The UE may refrain from transmitting an uplink signal on the impaired power limited port. In other words, the UE may blank the uplink signal on the impaired power limited port. The uplink signal may be a sounding reference signal (SRS) or a physical uplink shared channel (PUSCH) transmission. The UE may transmit, to the network node, the uplink signal on remaining non-impaired ports based at least in part on an uplink transmit power splitting applied amongst the remaining non-impaired ports. The network node may receive the uplink signal on certain ports. The network node may determine that the uplink signal is blanked on the impaired power limited port and not blanked on the remaining non-impaired ports. The network node may throttle a number of layers when the uplink signal is blanked on the impaired power limited port and when the uplink signal is transmitted on the remaining non-impaired ports.

In some examples, as an alternative, the UE may transmit the uplink signal on a plurality of ports (e.g., both impaired power limited ports and non-impaired ports), irrespective of an uplink transmit power associated with each of the ports. In this case, the UE may not blank the uplink signal on any ports of the plurality of ports. The network node may receive the uplink signal via the plurality of ports. The network node may determine an uplink transmit power associated with each port, of the plurality of ports. The network node may determine when an uplink transmit power associated with a certain port does not satisfy a certain threshold (e.g., the uplink transmit power may be too low for a current channel condition), which may allow the network node to distinguish between impaired power limited ports and non-impaired ports. The network node may throttle a number of layers when the uplink transmit power is below the certain threshold for certain ports.

Particular aspects of the subject matter described in this disclosure can be implemented to realize one or more of the following potential advantages. In some examples, by transmitting uplink signals on non-impaired ports and/or impaired power limited ports, the described techniques can be used to implement a layer (or rank) reduction instead of an uplink grant throttling, which would otherwise degrade a UE uplink performance. In some aspects, the network node may be able to detect when specific UE ports are impaired and power limited. The network node may detect when the specific UE ports are impaired and power limited based at least in part on certain ports being blanked, and/or based at least in part on uplink transmit powers associated with certain thresholds not satisfying the threshold. In this case, the network node may throttle the number of layers, instead of throttling the uplink grant (e.g., MCS and resource blocks), which would otherwise degrade an uplink performance of the UE. The network node may be able to detect, based at least in part on the uplink signal received via the plurality of ports, when the UE is subjected to a specific port power reduction, which may cause an overall carrier power limiting. The network node may not throttle the uplink grant, and instead may reduce the number of layers (or rank), which may cause less degradation to the UE's uplink performance. Therefore, when the UE is not limited to the same uplink transmit power on all ports involved in an uplink MIMO, the network node may be able to detect when only certain ports are associated with low uplink transmit power (e.g., only certain ports are power constrained), and the network node may not throttle the uplink grant, thereby improving an overall system performance.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

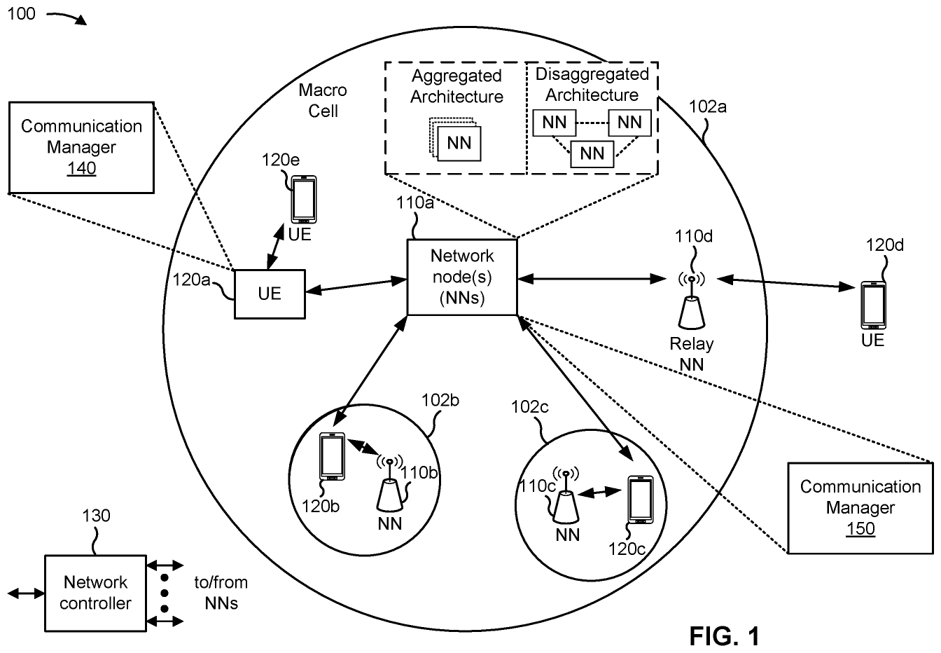

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components.

In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., the UE 120) may include a communication manager 140. As described in more detail elsewhere herein, the communication manager 140 may detect an impaired power limited port of the UE; refrain from transmitting an uplink signal on the impaired power limited port; and transmit the uplink signal on remaining non-impaired ports based at least in part on an uplink transmit power splitting applied amongst the remaining non-impaired ports. Additionally, or alternatively, the communication manager 140 may perform one or more other operations described herein.

In some aspects, a network node (e.g., the network node 110) may include a communication manager 150. As described in more detail elsewhere herein, the communication manager 150 may receive, via a plurality of ports, an uplink signal; detect, for a port associated with the plurality of ports, an uplink transmit power associated with the port, wherein the port is an impaired power limited port or a non-impaired port depending on the uplink transmit power associated with the port; and perform an action based at least in part on the uplink transmit power associated with the port. Additionally, or alternatively, the communication manager 150 may perform one or more other operations described herein.

As indicated above, FIG. 1 is provided as an example. Other examples may differ from what is described with regard to FIG. 1.

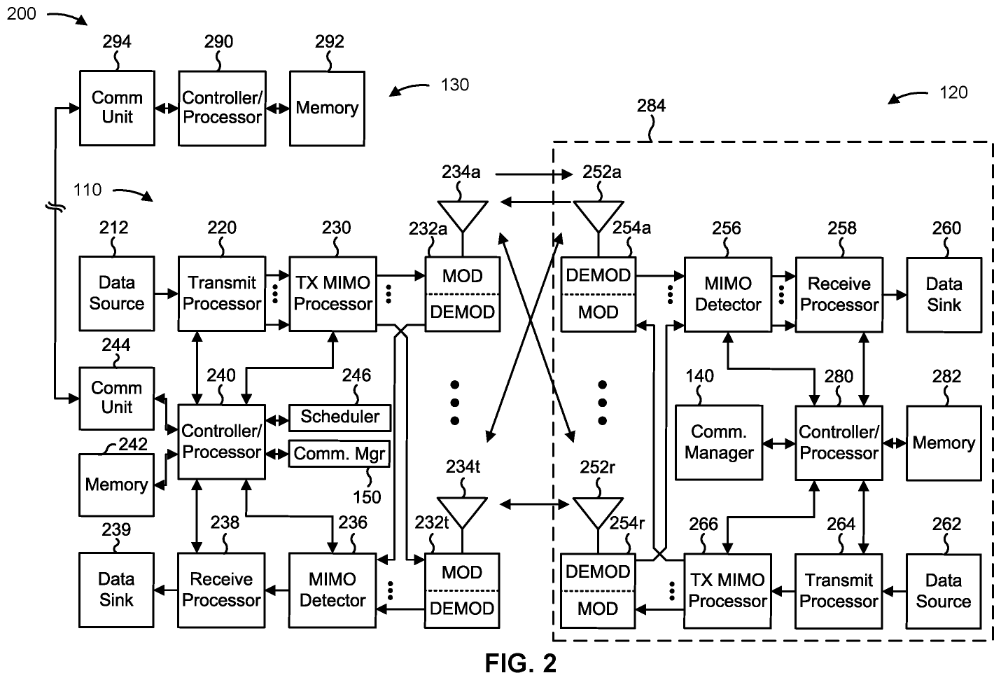

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) MIMO processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

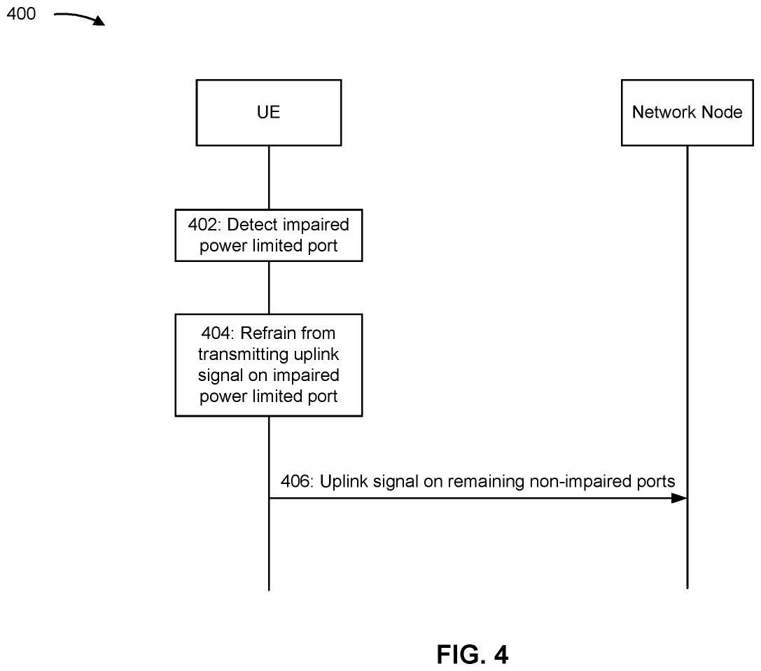

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-9).

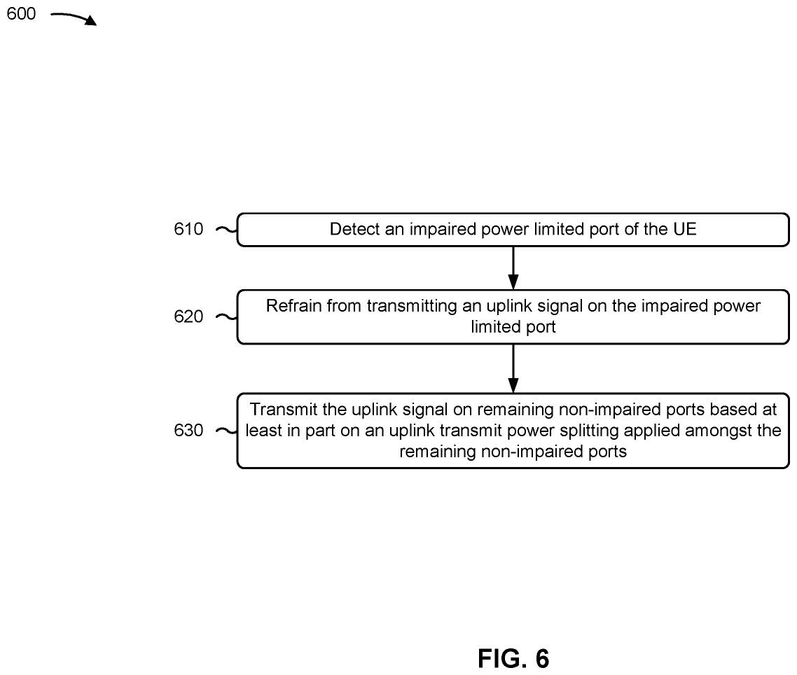

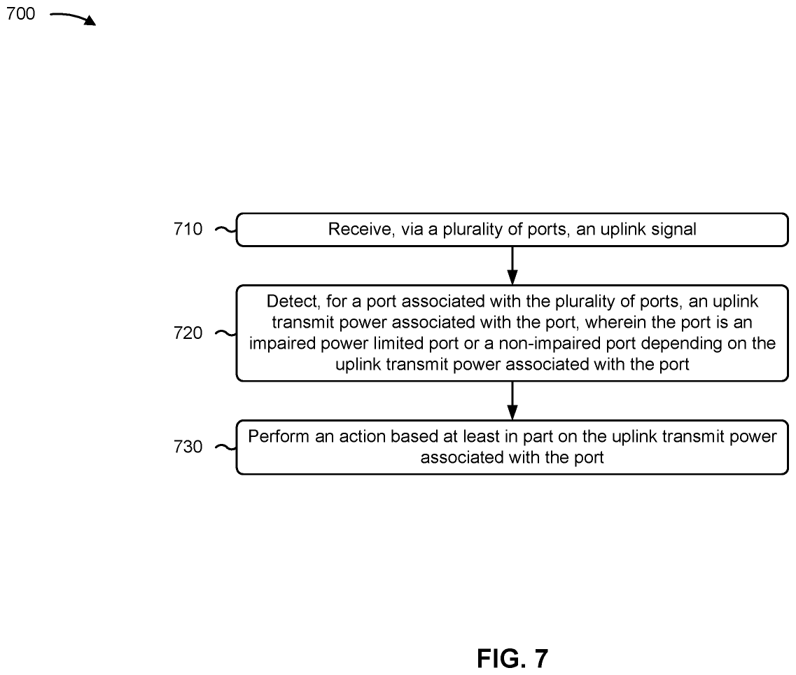

The controller/processor 240 of the network node 110, the controller/processor 280 of the UE 120, and/or any other component(s) of FIG. 2 may perform one or more techniques associated with transmitting on non-impaired ports and/or impaired power limited ports for layer reduction, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, a UE (e.g., the UE 120) includes means for detecting an impaired power limited port of the UE; means for refraining from transmitting an uplink signal on the impaired power limited port; and/or means for transmitting the uplink signal on remaining non-impaired ports based at least in part on an uplink transmit power splitting applied amongst the remaining non-impaired ports. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node) includes means for receiving, via a plurality of ports, an uplink signal; means for detecting, for a port associated with the plurality of ports, an uplink transmit power associated with the port, wherein the port is an impaired power limited port or a non-impaired port depending on the uplink transmit power associated with the port; and/or means for performing an action based at least in part on the uplink transmit power associated with the port. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

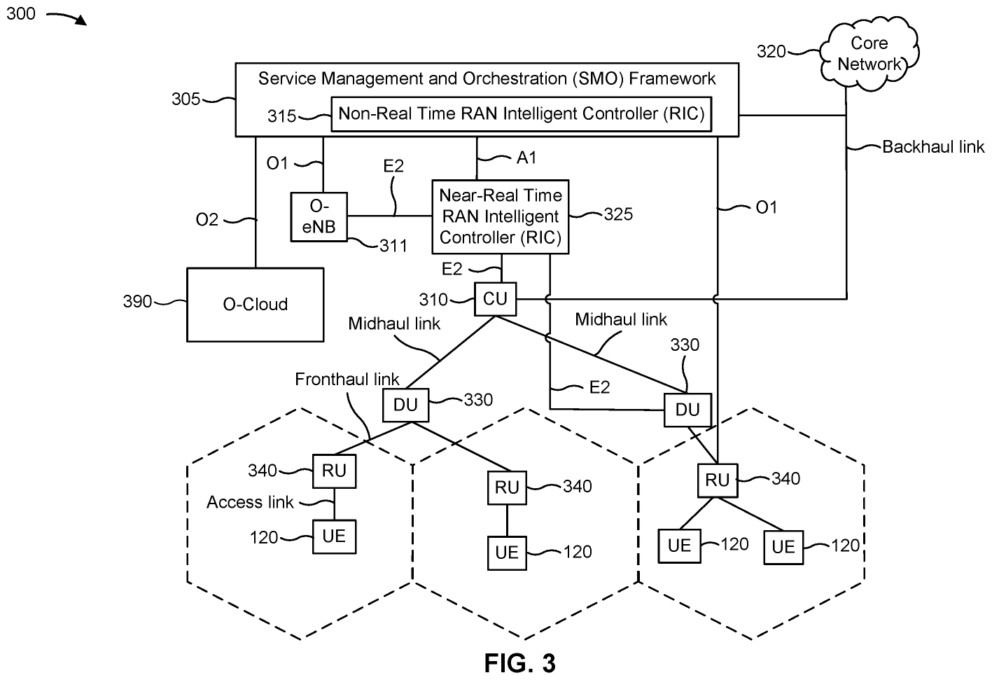

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

An uplink MIMO configuration may be deployed in an NR system to improve and boost an uplink throughput. In an uplink MIMO mode, a UE may use an indicated precoding matrix to multiplex multiple streams of data over one radio configuration using multiple physical antennas and/or ports (e.g., antenna ports). The one radio configuration may be associated with a single absolute radio-frequency channel number (ARFCN), bandwidth, and allocated resource blocks.

An uplink power control may be on a per carrier basis. The UE may split a computed uplink transmit power equally amongst active uplink ports for a given uplink transmission, in order to achieve a required uplink transmit power. As per a precoding matrix (e.g., a precoding matrix for a two-layer transmission using two ports) used for any form of uplink MIMO (e.g., coherent, non-coherent, or partially coherent), the uplink transmit power should be the same on all ports.

In some scenarios, an uplink transmit power of a certain port of the UE may be limited in relation to uplink transmit powers of other ports. For example, the uplink transmit power of the port may be limited due to the port being within a vicinity to a camera, a microphone, or some other subsystem, but other ports may not be subjected to such uplink transmit power limits. The uplink transmit power of the port may be limited, in relation to the uplink transmit powers of other ports, based at least in part on a SAR limit for different ports in different antenna groups. The uplink transmit power of the port may be limited due to a coexistence limit (e.g., different antenna isolation for a victim) or due to a thermal effect specific to a power amplifier. In such scenarios, not all ports may inherently be associated with the same uplink transmit power.

However, due to the requirement to transmit using the same uplink transmit power on all ports associated with uplink MIMO, the uplink transmit power for all ports may be limited to a minimum of a power permissible across all ports. In other words, when one port is limited to a low uplink transmit power, but other ports are able to support a high uplink transmit power, all ports must be constrained to the low uplink transmit power due to the requirement in uplink MIMO that all ports transmit using the same uplink transmit power. To satisfy the uplink MIMO requirement of having the same uplink transmit power on all ports, uplink transmit powers of all ports may become limited to the low uplink transmit power. Under such scenarios, an uplink transmit power of an overall carrier may become significantly power limited. An uplink signal-to-noise ratio (SNR) may be reduced, which may be reflected in a UE power headroom (PHR) report.

A network node may be unable to detect this specific scenario (e.g., a specific port power reduction causing an overall carrier power limiting), so the network node may throttle an uplink grant (e.g., throttle resource blocks and/or an MCS) in response to a relatively high uplink BLER as part of an outer loop link adaptation. When one port is power constrained (even though other ports may not be power constrained), the reduction in uplink transmit power and uplink SNR may reduce an overall performance of the UE and/or the network node. When all ports are forced to adapt to the same uplink transmit power, the UE may become power limited, which may lead to the relatively high uplink BLER. Further, when the network node throttles the uplink grant in response to the reduction in uplink transmit power and uplink SNR, without an ability to detect that the reduction in uplink transmit power and uplink SNR is due to the specific port power reduction, an overall performance of the UE and/or the network node may be degraded. The network node may throttle the uplink grant in response to the UE becoming power limited, which may lead to a significant uplink throughput degradation, especially when power on a specific transmit chain, port, and/or antenna is severely power limited. The network node may observe the same reduced uplink transmit power from all ports, even for an SRS, and the network node may receive a reduced PHR report. The network node may be unable to determine the specific scenario, such that the network node does not attempt a layer reduction instead of the uplink grant throttling. With the layer reduction, the UE may be able to use non-limited transmit chains, antennas, and/or ports for a reduced rank transmission, which would not cause such degradation to the UE.

In various aspects of techniques and apparatuses described herein, a UE may detect an impaired power limited port of the UE. The UE may detect that a certain port is the impaired power limited port based at least in part on an uplink transmit power associated with the port. The UE may refrain from transmitting an uplink signal on the impaired power limited port. In other words, the UE may blank the uplink signal on the impaired power limited port. The uplink signal may be an SRS or a PUSCH transmission. The UE may transmit, to a network node, the uplink signal on remaining non-impaired ports based at least in part on an uplink transmit power splitting applied amongst the remaining non-impaired ports. The network node may receive the uplink signal on certain ports. The network node may determine that the uplink signal is blanked on the impaired power limited port and not blanked on the remaining non-impaired ports. The network node may throttle a number of layers when the uplink signal is blanked on the impaired power limited port and when the uplink signal is transmitted on the remaining non-impaired ports.

Alternatively, the UE may transmit the uplink signal on a plurality of ports (e.g., both impaired power limited ports and non-impaired ports), irrespective of an uplink transmit power associated with each of the ports. In this case, the UE may not blank the uplink signal on any ports of the plurality of ports. The network node may receive the uplink signal via the plurality of ports. The network node may determine an uplink transmit power associated with each port, of the plurality of ports. The network node may determine when an uplink transmit power associated with a certain port does not satisfy a certain threshold (e.g., the uplink transmit power may be too low for a current channel condition), which may allow the network node to distinguish between impaired power limited ports and non-impaired ports. The network node may throttle a number of layers when the uplink transmit power is below the certain threshold for certain ports.

In some aspects, the network node may be able to detect when specific UE ports are impaired and power limited. The network node may detect when the specific UE ports are impaired and power limited based at least in part on certain ports being blanked, and/or based at least in part on uplink transmit powers associated with certain thresholds not satisfying the threshold. In this case, the network node may throttle the number of layers, instead of throttling an uplink grant (e.g., MCS and resource blocks), which would otherwise degrade an uplink performance of the UE. The network node may be able to detect, based at least in part on the uplink signal received via the plurality of ports, when the UE is subjected to a specific port power reduction, which may cause an overall carrier power limiting. The network node may not throttle the uplink grant, and instead may reduce the number of layers (or rank), which may cause less degradation to the UE's uplink performance. Therefore, when the UE is not limited to the same uplink transmit power on all ports involved in an uplink MIMO, the network node may be able to detect when only certain ports are associated with low uplink transmit power (e.g., only certain ports are power constrained), and the network node may not throttle the uplink grant, thereby improving an overall system performance.

FIG. 4 is a diagram illustrating an example 400 associated with transmitting on non-impaired ports and/or impaired power limited ports for layer reduction, in accordance with the present disclosure. As shown in FIG. 4, example 400 includes communication between a UE (e.g., UE 120) and a network node (e.g., network node 110). In some aspects, the UE and the network node may be included in a wireless network, such as wireless network 100. The UE may be configured for uplink MIMO.

As shown by reference number 402, the UE may detect an impaired power limited port of the UE. In some aspects, when detecting the impaired power limited port, the UE may determine a minimum allowed uplink transmit power of a port. The UE may determine a maximum allowed uplink transmit power of the port. The UE may calculate a delta value between the minimum allowed uplink transmit power and the maximum allowed uplink transmit power. The UE may determine that the delta value satisfies a delta threshold value. The UE may determine that the port is the impaired power limited port based at least in part on the delta value satisfying the delta threshold value. In some aspects, when detecting the impaired power limited port, the UE may identify an individual per-port permissible uplink transmit power of a port. The UE may determine that the individual per-port permissible uplink transmit power satisfies an absolute threshold value. The UE may determine that the port is the impaired power limited port based at least in part on the individual per-port permissible uplink transmit power satisfying the absolute threshold value.

In some aspects, in an SRS based adaptation, the UE may check a minimum (P_{min,i}) and a maximum (P_{max,i}) of an uplink transmit power that is allowed or permissible in an uplink power constrained scenario, where “i” denotes a port (or UE antenna port). The UE may determine the minimum and maximum allowed/permitted uplink transmit powers across a plurality of ports. The UE may determine, for a given port, a delta value between the minimum and the maximum of the uplink transmit power that is allowed or permissible during an uplink power constrained scenario. When the delta value satisfies a delta threshold value, the UE may determine that the port is currently power limited (e.g., the port is an impaired power limited port).

In some aspects, the UE may check and compare its individual per-port current permissible uplink transmit power to an absolute threshold value, and based at least in part on the comparison, the UE may determine that a port is currently power limited. Further, the UE may check its PHR report, which may indicate whether the UE is power limited (e.g., at least one port of the UE is power limited) as well. Depending on the delta value in relation to the delta threshold value and/or the UE's individual per-port current permissible uplink transmit power in relation to the absolute threshold value, the UE may be able to detect an impaired power limited port. The delta threshold value and/or the absolute threshold value may be set by the UE and/or configured by the network node. An “impaired power limited port” may be a port that is associated with a relatively low uplink transmit power. For example, the uplink transmit power of the port may not satisfy a certain threshold, which may cause the port to be impaired and/or power limited.

As shown by reference number 404, the UE may refrain from transmitting an uplink signal on the impaired power limited port. The uplink signal may be an SRS. The UE, when refraining from transmitting the uplink signal on the impaired power limited port, may blank the uplink signal on the impaired power limited port and/or blank the impaired power limited port. When blanking the uplink signal on the impaired power limited port, the UE may refrain from transmitting the uplink signal on the impaired power limited port. In other words, after detecting the impaired power limited port, when the uplink signal is available for transmission, the UE may avoid transmitting the uplink signal on the impaired power limited port.

As shown by reference number 406, the UE may transmit, to the network node, the uplink signal on remaining non-impaired ports. The UE may transmit the uplink signal based at least in part on an uplink transmit power splitting applied amongst the remaining non-impaired ports. In other words, the UE may evenly distribute an available uplink transmit power, for the uplink signal, to the remaining non-impaired ports.

In some aspects, after detecting the impaired power limited port, the UE may refrain from transmitting an uplink codebook SRS on the impaired power limited port. The UE may transmit an SRS on non-impaired ports by applying an uplink transmit power splitting amongst remaining non-impaired ports (e.g., the rest of the active non-impaired ports). In other words, the UE may not transmit any SRS on the impaired power limited port, and instead may only transmit the SRS on the remaining non-impaired ports.

In some aspects, the network node may determine to throttle a number of layers based at least in part on a receipt of the uplink signal on the remaining non-impaired ports and not on the impaired power limited port. The network node may throttle the number of layers when the uplink signal is blanked on the impaired power limited port and the uplink signal is transmitted on the remaining non-impaired ports. The UE may not throttle an uplink grant when the uplink signal is blanked on the impaired power limited port and the uplink signal is transmitted on the remaining non-impaired ports. “Throttle” may refer to reducing the number of layers and/or reducing the uplink grant, where reducing the uplink grant is associated with allocating fewer uplink resources for the UE to perform uplink transmissions, thereby affecting an uplink performance of the UE.

In some aspects, the network node may receive the SRS via the remaining non-impaired ports. The network node may detect that the SRS is not received via a certain port, which may allow the network node to infer that the port in which the SRS is not received is actually the impaired power limited port. The network node may be able to determine which of the UE's specific ports are being impaired and power limited, and which of the UE's specific ports are non-impaired. When the network node determines that some of the UE's ports are impaired and power limited, the network node may throttle the number of layers (e.g., rank reduction), while keeping the uplink grant (e.g., MCS and/or resource blocks) unimpacted. In this case, the network node may not throttle the uplink grant, thereby improving a performance of the UE and/or the network node.

In some aspects, by only blanking the certain impaired power limited port, and by transmitting the SRS on the non-impaired ports, an overall transmit power of a carrier may not become significantly power limited because the UE does not need to reduce the uplink transmit power for all ports. Throttling the number of layers instead of the uplink grant may improve the performance of the UE and/or the network node, as compared to running the UE in an uplink MIMO mode in a power limited scenario in which the uplink grant is severely limited. After falling back to a single layer, the network node may be allowed an opportunity to configure the UE in an uplink carrier aggregation (ULCA) mode (as available in the region) using a freed-up UE transmit chain. After the UE's impaired antenna transmit limit is relaxed, the UE may fall back to a default behavior (e.g., a non-ULCA mode).

As indicated above, FIG. 4 is provided as an example. Other examples may differ from what is described with regard to FIG. 4.

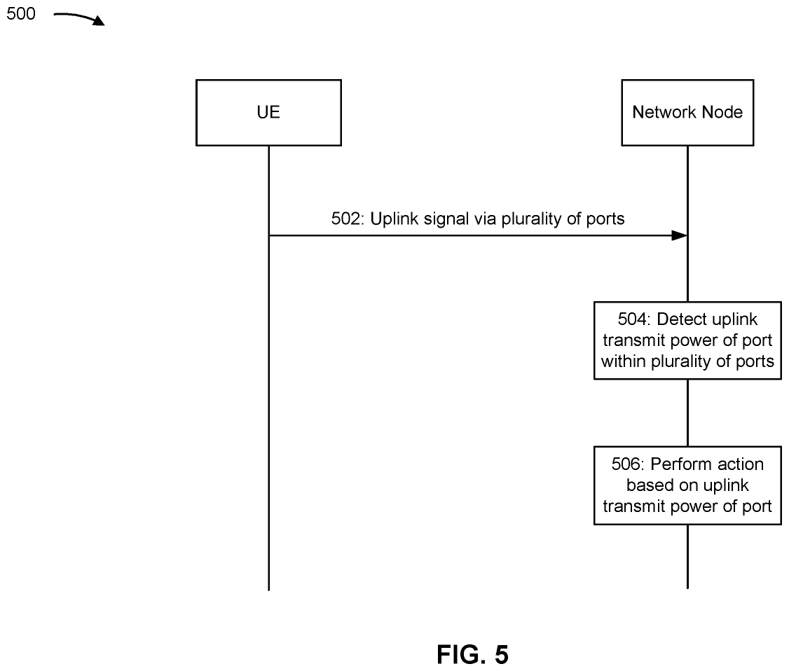

FIG. 5 is a diagram illustrating an example 500 associated with transmitting on non-impaired ports and/or impaired power limited ports for layer reduction, in accordance with the present disclosure. As shown in FIG. 5, example 500 includes communication between a UE (e.g., UE 120) and a network node (e.g., network node 110). In some aspects, the UE and the network node may be included in a wireless network, such as wireless network 100. The UE may be configured for uplink MIMO.

As shown by reference number 502, the UE may transmit, to the network node, an uplink signal via a plurality of ports of the UE. The uplink signal may be an SRS. A power splitting for the SRS may be among one or more impaired power limited ports and/or one or more non-impaired ports, of the plurality of ports. Alternatively, the uplink signal may be a PUSCH transmission. A power splitting for the PUSCH transmission may be among the one or more impaired power limited ports and/or the one or more non-impaired ports, of the plurality of ports. The UE may transmit the uplink signal via the plurality of ports, even though some ports may be impaired power limited ports and some ports may be non-impaired ports. In other words, regardless of whether a given port is an impaired power limited port or a non-impaired port, depending on the uplink transmit power associated with the port, the UE may transmit the uplink signal via that port. In this case, the UE may not blank a certain port when an uplink transmit power associated with that port is below a certain threshold. Rather, even when the uplink transmit power of that port is below the certain threshold, the UE may transmit the uplink signal on that port. The network node may receive, via the plurality of ports, the uplink signal.

As shown by reference number 504, the network node may detect, for a port associated with the plurality of ports, the uplink transmit power associated with the port. The UE may determine, based on the uplink transmit power associated with the port, whether the port is an impaired power limited port or a non-impaired port. In some cases, the network node may determine, from the plurality of ports, a first set of ports that are the impaired power limited ports and a second set of ports that are the non-impaired ports, based at least in part on uplink transmit powers associated with each port of the plurality of ports. After receiving the uplink signal, the network node may understand when the UE's specific ports are being impaired and power limited.

As shown by reference number 506, the network node may perform an action based at least in part on the uplink transmit power associated with the port. The network node may determine that the uplink transmit power associated with the port does not satisfy a threshold for a current channel condition. In this case, the network node, when performing the action, may throttle a number of layers based at least in part on the uplink transmit power associated with the port. The network node may perform a rank reduction, instead of an uplink grant throttling, based at least in part on the uplink transmit power. When the uplink transmit power associated with the port does not satisfy the threshold, the network node may not throttle the number of layers.

In some aspects, in an SRS based adaptation, the UE may transmit the SRS using a limited uplink transmit power on an impaired port (or impaired antenna). In this case, the network node may make a decision based at least in part on the received SRS. For example, when a limited uplink transmit power of a certain port is too low for a certain channel condition, the network node may determine to drop or reduce a rank for the UE. Otherwise, the network node may determine to throttle an uplink grant. In some aspects, in certain cases, the UE may blank an SRS on some ports, and in other cases, the UE may not blank the SRS on some ports and instead transmit the SRS on all ports of the UE.

In some aspects, in a PUSCH based adaptation, the UE may use a PUSCH to trigger a more intelligent adaptation at the network node. The UE may transmit the PUSCH (e.g., an initial few PUSCH transmissions) with power splitting among impaired power limited ports and non-impaired ports. When using the impaired power limited ports, the PUSCH transmission may be transmitted at a limited uplink transmit power. The PUSCH transmission may be transmitted at relatively high uplink transmit powers on the non-impaired ports. The network node may receive the PUSCH transmission via the ports, which may include both the impaired power limited ports and the non-impaired ports. The network node may detect, for each port, a corresponding uplink transmit power, which may allow the network node to detect which ports are impaired power limited ports and which ports are non-impaired ports. The network node may determine when a UE's specific port (or antenna) is transmit power limited, and the network node may quantify an impact of that reduced transmit power under current channel conditions. The UE may wait for a configurable amount of time, which may allow the network node to adapt and trigger an uplink rank reduction, instead of throttling the uplink grant. When the network node does not trigger an intended behavior (e.g., layer/rank reduction), the UE may fallback to blanking certain ports and/or only transmitting an SRS (e.g., not a PUSCH transmission).

As indicated above, FIG. 5 is provided as an example. Other examples may differ from what is described with regard to FIG. 5.

FIG. 6 is a diagram illustrating an example process 600 performed, for example, at a UE or an apparatus of a UE, in accordance with the present disclosure. Example process 600 is an example where the apparatus or the UE (e.g., UE 120) performs operations associated with transmitting on non-impaired ports for layer reduction.

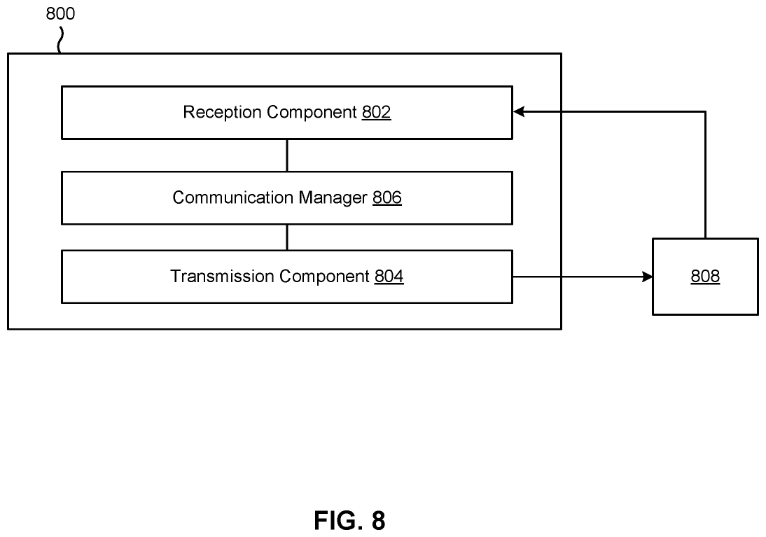

As shown in FIG. 6, in some aspects, process 600 may include detecting an impaired power limited port of the UE (block 610). For example, the UE (e.g., using communication manager 806, depicted in FIG. 8) may detect an impaired power limited port of the UE, as described above.

As further shown in FIG. 6, in some aspects, process 600 may include refraining from transmitting an uplink signal on the impaired power limited port (block 620). For example, the UE (e.g., using communication manager 806, depicted in FIG. 8) may refrain from transmitting an uplink signal on the impaired power limited port, as described above.

As further shown in FIG. 6, in some aspects, process 600 may include transmitting the uplink signal on remaining non-impaired ports based at least in part on an uplink transmit power splitting applied amongst the remaining non-impaired ports (block 630). For example, the UE (e.g., using transmission component 804 and/or communication manager 806, depicted in FIG. 8) may transmit the uplink signal on remaining non-impaired ports based at least in part on an uplink transmit power splitting applied amongst the remaining non-impaired ports, as described above.

Process 600 may include additional aspects, such as any single aspect or any combination of aspects described below and/or in connection with one or more other processes described elsewhere herein.

In a first aspect, process 600 includes determining a minimum allowed uplink transmit power of a port, determining a maximum allowed uplink transmit power of the port, calculating a delta value between the minimum allowed uplink transmit power and the maximum allowed uplink transmit power, determining that the delta value satisfies a delta threshold value, and determining that the port is the impaired power limited port based at least in part on the delta value satisfying the delta threshold value.

In a second aspect, alone or in combination with the first aspect, process 600 includes identifying an individual per-port permissible uplink transmit power of a port, determining that the individual per-port permissible uplink transmit power satisfies an absolute threshold value, and determining that the port is the impaired power limited port based at least in part on the individual per-port permissible uplink transmit power satisfying the absolute threshold value.

In a third aspect, alone or in combination with one or more of the first and second aspects, the uplink signal on the impaired power limited port is blanked.

In a fourth aspect, alone or in combination with one or more of the first through third aspects, a number of layers is throttled based at least in part on the uplink signal being blanked on the impaired power limited port and the uplink signal being transmitted on the remaining non-impaired ports.

In a fifth aspect, alone or in combination with one or more of the first through fourth aspects, an uplink grant is not throttled based at least in part on the uplink signal being blanked on the impaired power limited port and the uplink signal being transmitted on the remaining non-impaired ports.

In a sixth aspect, alone or in combination with one or more of the first through fifth aspects, the UE is configured for uplink MIMO.

In a seventh aspect, alone or in combination with one or more of the first through sixth aspects, the uplink signal is an SRS.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a network node or an apparatus of a network node, in accordance with the present disclosure. Example process 700 is an example where the apparatus or the network node (e.g., network node 110) performs operations associated with transmitting on non-impaired ports for layer reduction.

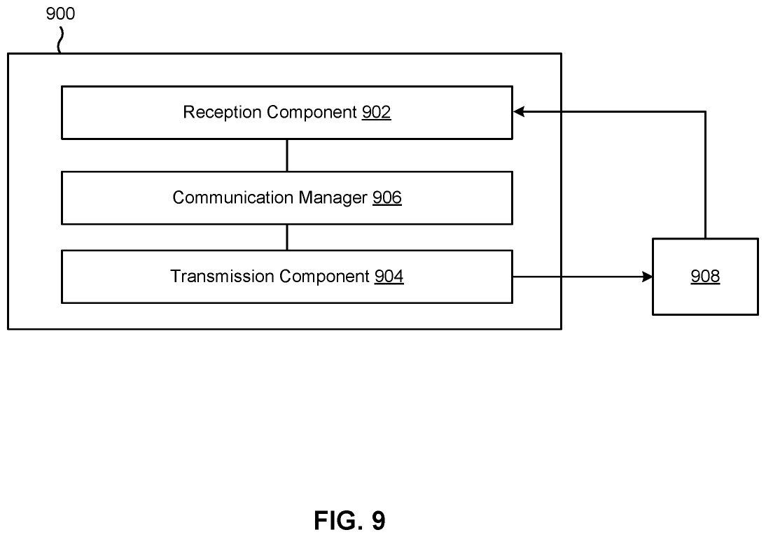

As shown in FIG. 7, in some aspects, process 700 may include receiving, via a plurality of ports, an uplink signal (block 710). For example, the network node (e.g., using reception component 902 and/or communication manager 906, depicted in FIG. 9) may receive, via a plurality of ports, an uplink signal, as described above.

As further shown in FIG. 7, in some aspects, process 700 may include detecting, for a port associated with the plurality of ports, an uplink transmit power associated with the port, wherein the port is an impaired power limited port or a non-impaired port depending on the uplink transmit power associated with the port (block 720). For example, the network node (e.g., using communication manager 906, depicted in FIG. 9) may detect, for a port associated with the plurality of ports, an uplink transmit power associated with the port, wherein the port is an impaired power limited port or a non-impaired port depending on the uplink transmit power associated with the port, as described above.

As further shown in FIG. 7, in some aspects, process 700 may include performing an action based at least in part on the uplink transmit power associated with the port (block 730). For example, the network node (e.g., using communication manager 906, depicted in FIG. 9) may perform an action based at least in part on the uplink transmit power associated with the port, as described above.

Process 700 may include additional aspects, such as any single aspect or any combination of aspects described below and/or in connection with one or more other processes described elsewhere herein.

In a first aspect, process 700 includes determining that the uplink transmit power associated with the port does not satisfy a threshold for a current channel condition, and wherein performing the action comprises throttling a number of layers based at least in part on the uplink transmit power associated with the port.

In a second aspect, alone or in combination with the first aspect, process 700 includes performing a rank reduction and refrain from performing an uplink grant throttling, based at least in part on the uplink transmit power.

In a third aspect, alone or in combination with one or more of the first and second aspects, the uplink signal is an SRS.

In a fourth aspect, alone or in combination with one or more of the first through third aspects, power splitting for the uplink signal is among one or more impaired power limited ports or one or more non-impaired ports.

In a fifth aspect, alone or in combination with one or more of the first through fourth aspects, process 700 includes determining, from the plurality of ports, a first set of ports that are impaired power limited ports and a second set of ports that are non-impaired ports, based at least in part on uplink transmit powers associated with each port of the plurality of ports.

In a sixth aspect, alone or in combination with one or more of the first through fifth aspects, the uplink signal is associated with a PUSCH transmission.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 140 described in connection with FIG. 1. As shown, the apparatus 800 may communicate with another apparatus 808, such as a UE or a network node (such as a CU, a DU, an RU, or a base station), using the reception component 802 and the transmission component 804.

In some aspects, the apparatus 800 may be configured to perform one or more operations described herein in connection with FIGS. 4-5. Additionally, or alternatively, the apparatus 800 may be configured to perform one or more processes described herein, such as process 600 of FIG. 6. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 808. In some aspects, the transmission component 804 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 804 may be co-located with the reception component 802 in one or more transceivers.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The communication manager 806 may detect an impaired power limited port of the UE. The communication manager 806 may refrain from transmitting an uplink signal on the impaired power limited port. The transmission component 804 may transmit the uplink signal on remaining non-impaired ports based at least in part on an uplink transmit power splitting applied amongst the remaining non-impaired ports.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 4-5. Additionally, or alternatively, the apparatus 900 may be configured to perform one or more processes described herein, such as process 700 of FIG. 7. In some aspects, the apparatus 900 and/or one or more components shown in FIG. 9 may include one or more components of the network node described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 902 and/or the transmission component 904 may include or may be included in a network interface. The network interface may be configured to obtain and/or output signals for the apparatus 900 via one or more communications links, such as a backhaul link, a midhaul link, and/or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 904 may be co-located with the reception component 902 in one or more transceivers.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive, via a plurality of ports, an uplink signal. The communication manager 906 may detect, for a port associated with the plurality of ports, an uplink transmit power associated with the port, wherein the port is an impaired power limited port or a non-impaired port depending on the uplink transmit power associated with the port. The communication manager 906 may perform an action based at least in part on the uplink transmit power associated with the port.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: detecting an impaired power limited port of the UE; refraining from transmitting an uplink signal on the impaired power limited port; and transmitting the uplink signal on remaining non-impaired ports based at least in part on an uplink transmit power splitting applied amongst the remaining non-impaired ports.

Aspect 2: The method of Aspect 1, wherein detecting the impaired power limited port comprises: determining a minimum allowed uplink transmit power of a port; determining a maximum allowed uplink transmit power of the port; calculating a delta value between the minimum allowed uplink transmit power and the maximum allowed uplink transmit power; determining that the delta value satisfies a delta threshold value; and determining that the port is the impaired power limited port based at least in part on the delta value satisfying the delta threshold value.

Aspect 3: The method of any of Aspects 1-2, wherein detecting the impaired power limited port comprises: identifying an individual per-port permissible uplink transmit power of a port; determining that the individual per-port permissible uplink transmit power satisfies an absolute threshold value; and determining that the port is the impaired power limited port based at least in part on the individual per-port permissible uplink transmit power satisfying the absolute threshold value.

Aspect 4: The method of any of Aspects 1-3, wherein the uplink signal on the impaired power limited port is blanked.

Aspect 5: The method of Aspect 4, wherein a number of layers is throttled based at least in part on the uplink signal being blanked on the impaired power limited port and the uplink signal being transmitted on the remaining non-impaired ports.

Aspect 6: The method of Aspect 4, wherein an uplink grant is not throttled based at least in part on the uplink signal being blanked on the impaired power limited port and the uplink signal being transmitted on the remaining non-impaired ports.

Aspect 7: The method of any of Aspects 1-6, wherein the UE is configured for uplink multiple-input multiple-output (MIMO).

Aspect 8: The method of any of Aspects 1-7, wherein the uplink signal is a sounding reference signal (SRS).

Aspect 9: A method of wireless communication performed by a network node, comprising: receiving, via a plurality of ports, an uplink signal; detecting, for a port associated with the plurality of ports, an uplink transmit power associated with the port, wherein the port is an impaired power limited port or a non-impaired port depending on the uplink transmit power associated with the port; and performing an action based at least in part on the uplink transmit power associated with the port.

Aspect 10: The method of Aspect 9, further comprising: determining that the uplink transmit power associated with the port does not satisfy a threshold for a current channel condition, and wherein performing the action comprises throttling a number of layers based at least in part on the uplink transmit power associated with the port. wherein performing the action comprises throttling a number of layers based at least in part on the uplink transmit power associated with the port.

Aspect 11: The method of any of Aspects 9-10, wherein performing the action comprises performing a rank reduction and refrain from performing an uplink grant throttling, based at least in part on the uplink transmit power.

Aspect 12: The method of any of Aspects 9-11, wherein the uplink signal is a sounding reference signal (SRS).

Aspect 13: The method of any of Aspects 9-12, wherein power splitting for the uplink signal is among one or more impaired power limited ports or one or more non-impaired ports.

Aspect 14: The method of any of Aspects 9-13, further comprising: determining, from the plurality of ports, a first set of ports that are impaired power limited ports and a second set of ports that are non-impaired ports, based at least in part on uplink transmit powers associated with each port of the plurality of ports.

Aspect 15: The method of any of Aspects 9-14, wherein the uplink signal is associated with a physical uplink shared channel (PUSCH) transmission.

Aspect 16: A method of wireless communication performed by a user equipment (UE), comprising: detecting an impaired power limited port of the UE; transmitting an uplink signal on the impaired power limited port, wherein the uplink signal is associated with a limited transmit power based at least in part on being transmitted on the impaired power limited port; and transmitting the uplink signal on remaining non-impaired ports.

Aspect 17: The method of Aspect 16, wherein a number of layers is throttled based at least in part on the uplink signal being transmitted on the impaired power limited port.

Aspect 18: The method of any of Aspects 16-17, wherein an uplink grant is not throttled based at least in part on the uplink signal being transmitted on the impaired power limited port.

Aspect 19: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-8 and 18.

Aspect 20: An apparatus for wireless communication at a device, the apparatus comprising one or more memories and one or more processors coupled to the one or more memories, the one or more processors configured to cause the device to perform the method of one or more of Aspects 1-8 and 18.

Aspect 21: An apparatus for wireless communication, the apparatus comprising at least one means for performing the method of one or more of Aspects 1-8.

Aspect 22: A non-transitory computer-readable medium storing code for wireless communication, the code comprising instructions executable by one or more processors to perform the method of one or more of Aspects 1-8 and 18.

Aspect 23: A non-transitory computer-readable medium storing a set of instructions for wireless communication, the set of instructions comprising one or more instructions that, when executed by one or more processors of a device, cause the device to perform the method of one or more of Aspects 1-8 and 18.

Aspect 24: A device for wireless communication, the device comprising a processing system that includes one or more processors and one or more memories coupled with the one or more processors, the processing system configured to cause the device to perform the method of one or more of Aspects 1-8 and 18.

Aspect 25: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 9-15.

Aspect 26: An apparatus for wireless communication at a device, the apparatus comprising one or more memories and one or more processors coupled to the one or more memories, the one or more processors configured to cause the device to perform the method of one or more of Aspects 9-15.

Aspect 27: An apparatus for wireless communication, the apparatus comprising at least one means for performing the method of one or more of Aspects 9-15.

Aspect 28: A non-transitory computer-readable medium storing code for wireless communication, the code comprising instructions executable by one or more processors to perform the method of one or more of Aspects 9-15.

Aspect 29: A non-transitory computer-readable medium storing a set of instructions for wireless communication, the set of instructions comprising one or more instructions that, when executed by one or more processors of a device, cause the device to perform the method of one or more of Aspects 9-15.

Aspect 30: A device for wireless communication, the device comprising a processing system that includes one or more processors and one or more memories coupled with the one or more processors, the processing system configured to cause the device to perform the method of one or more of Aspects 9-15.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
one or more memories; and
one or more processors coupled to the one or more memories, the one or more processors configured to:
detect an impaired power limited port of the UE;
refrain from transmitting an uplink signal on the impaired power limited port; and
transmit the uplink signal on remaining non-impaired ports based at least in part on an uplink transmit power splitting applied amongst the remaining non-impaired ports.

2. The apparatus of claim 1, wherein the one or more processors, when detecting the impaired power limited port, are configured to:
determine a minimum allowed uplink transmit power of a port;
determine a maximum allowed uplink transmit power of the port;
calculate a delta value between the minimum allowed uplink transmit power and the maximum allowed uplink transmit power;
determine that the delta value satisfies a delta threshold value; and
determine that the port is the impaired power limited port based at least in part on the delta value satisfying the delta threshold value.

3. The apparatus of claim 1, wherein the one or more processors, when detecting the impaired power limited port, are configured to:
identify an individual per-port permissible uplink transmit power of a port;
determine that the individual per-port permissible uplink transmit power satisfies an absolute threshold value; and
determine that the port is the impaired power limited port based at least in part on the individual per-port permissible uplink transmit power satisfying the absolute threshold value.

4. The apparatus of claim 1, wherein the uplink signal on the impaired power limited port is blanked.

5. The apparatus of claim 4, wherein a number of layers is throttled based at least in part on the uplink signal being blanked on the impaired power limited port and the uplink signal being transmitted on the remaining non-impaired ports.

6. The apparatus of claim 4, wherein an uplink grant is not throttled based at least in part on the uplink signal being blanked on the impaired power limited port and the uplink signal being transmitted on the remaining non-impaired ports.

7. The apparatus of claim 1, wherein the UE is configured for uplink multiple-input multiple-output (MIMO).

8. The apparatus of claim 1, wherein the uplink signal is a sounding reference signal (SRS).

9. An apparatus for wireless communication at a network node, comprising:
one or more memories; and
one or more processors coupled to the one or more memories, the one or more processors configured to:
receive, via a plurality of ports, an uplink signal;
detect, for a port associated with the plurality of ports, an uplink transmit power associated with the port, wherein the port is an impaired power limited port or a non-impaired port depending on the uplink transmit power associated with the port; and
perform an action based at least in part on the uplink transmit power associated with the port.

10. The apparatus of claim 9, wherein:
the one or more processors are further configured to determine that the uplink transmit power associated with the port does not satisfy a threshold for a current channel condition, and
the one or more processors, when performing the action, are configured to throttle a number of layers based at least in part on the uplink transmit power associated with the port.

11. The apparatus of claim 9, wherein the one or more processors, when performing the action, are configured to:
perform a rank reduction and refrain from performing an uplink grant throttling, based at least in part on the uplink transmit power.

12. The apparatus of claim 9, wherein the uplink signal is a sounding reference signal (SRS).

13. The apparatus of claim 9, wherein power splitting for the uplink signal is among one or more impaired power limited ports or one or more non-impaired ports.

14. The apparatus of claim 9, wherein the one or more processors are further configured to:
determine, from the plurality of ports, a first set of ports that are impaired power limited ports and a second set of ports that are non-impaired ports, based at least in part on uplink transmit powers associated with each port of the plurality of ports.

15. The apparatus of claim 9, wherein the uplink signal is associated with a physical uplink shared channel (PUSCH) transmission.

16. A method of wireless communication performed by a user equipment (UE), comprising:
detecting an impaired power limited port of the UE;
refraining from transmitting an uplink signal on the impaired power limited port; and
transmitting the uplink signal on remaining non-impaired ports based at least in part on an uplink transmit power splitting applied amongst the remaining non-impaired ports.

17. The method of claim 16, wherein detecting the impaired power limited port comprises:
determining a minimum allowed uplink transmit power of a port;
determining a maximum allowed uplink transmit power of the port;
calculating a delta value between the minimum allowed uplink transmit power and the maximum allowed uplink transmit power;
determining that the delta value satisfies a delta threshold value; and
determining that the port is the impaired power limited port based at least in part on the delta value satisfying the delta threshold value.

18. The method of claim 16, wherein detecting the impaired power limited port comprises:
identifying an individual per-port permissible uplink transmit power of a port;
determining that the individual per-port permissible uplink transmit power satisfies an absolute threshold value; and
determining that the port is the impaired power limited port based at least in part on the individual per-port permissible uplink transmit power satisfying the absolute threshold value.

19. The method of claim 16, wherein the uplink signal on the impaired power limited port is blanked.

20. The method of claim 19, wherein a number of layers is throttled based at least in part on the uplink signal being blanked on the impaired power limited port and the uplink signal being transmitted on the remaining non-impaired ports.

21. The method of claim 19, wherein an uplink grant is not throttled based at least in part on the uplink signal being blanked on the impaired power limited port and the uplink signal being transmitted on the remaining non-impaired ports.

22. The method of claim 16, wherein the UE is configured for uplink multiple-input multiple-output (MIMO).

23. The method of claim 16, wherein the uplink signal is a sounding reference signal (SRS).

24. A method of wireless communication performed by a network node, comprising:
receiving, via a plurality of ports, an uplink signal;
detecting, for a port associated with the plurality of ports, an uplink transmit power associated with the port, wherein the port is an impaired power limited port or a non-impaired port depending on the uplink transmit power associated with the port; and
performing an action based at least in part on the uplink transmit power associated with the port.

25. The method of claim 24, further comprising:
determining that the uplink transmit power associated with the port does not satisfy a threshold for a current channel condition, and
wherein performing the action comprises throttling a number of layers based at least in part on the uplink transmit power associated with the port.

26. The method of claim 24, wherein performing the action comprises performing a rank reduction and refrain from performing an uplink grant throttling, based at least in part on the uplink transmit power.

27. The method of claim 24, wherein the uplink signal is a sounding reference signal (SRS).

28. The method of claim 24, wherein power splitting for the uplink signal is among one or more impaired power limited ports or one or more non-impaired ports.

29. The method of claim 24, further comprising:
determining, from the plurality of ports, a first set of ports that are impaired power limited ports and a second set of ports that are non-impaired ports, based at least in part on uplink transmit powers associated with each port of the plurality of ports.

30. The method of claim 24, wherein the uplink signal is associated with a physical uplink shared channel (PUSCH) transmission.
